(19) United States
(12) Patent Application Publication
(10) Pub. No.: US 2013/0225738 A1
(43) Pub. Date: Aug. 29, 2013

(54) POLYETHYLENE COMPOSITIONS HAVING REDUCED PLATE OUT, AND FILMS MADE THEREFROM HAVING REDUCED BLOOMING

(71) Applicants: John O. Osby, Lake Jackson, TX (US); Brian W. Walther, Clute, TX (US); Jose E. Ruiz, Sugar Land, TX (US); Jon W. Hobson, Lake Jackson, TX (US); Cristina Serrat, Sugar Land, TX (US)

(72) Inventors: John O. Osby, Lake Jackson, TX (US); Brian W. Walther, Clute, TX (US); Jose E. Ruiz, Sugar Land, TX (US); Jon W. Hobson, Lake Jackson, TX (US); Cristina Serrat, Sugar Land, TX (US)

(73) Assignee: Dow Global Technologies LLC, Midland, MI (US)

(21) Appl. No.: 13/504,203

(22) PCT Filed: Oct. 17, 2011
(86) PCT No.: PCT/US11/56553

§ 371 Date: Apr. 26, 2012

Related U.S. Application Data
(60) Provisional application No. 61/394,401, filed on Oct. 19, 2010.

(51) Int. Cl. C08L 23/06

(52) U.S. Cl. CPC C08L 23/06
USPC 524/291

(57) ABSTRACT

The instant invention provides polyethylene compositions having reduced plate out, and films made therefrom having reduced blooming. The polyethylene composition suitable for film applications according to the present invention comprises the melt blending product of: (a) an ethylene based polymer; (b) a first antioxidant system comprising one or more antioxidants selected from the group consisting of Octadecyl-3-(3,5-di-tert.butyl-4-hydroxyphenyl)-propionate; Pentaerythritol Tetrakis (3-(3,5-di-tert-butyl-4-hydroxyphenyl)propionate); and combinations thereof; (c) a second antioxidant system comprising a liquid phosphite corresponding to the formula [4-(2-methylbutan-2-yl)phenyl]x[2,4-bis(2-methylbutan-2-yl)phenyl]3-x phosphate, wherein x=0, 1, 2, 3, or combinations thereof; and (d) optionally one or more neutralizing agents.

### CROSS-REFERENCE TO RELATED APPLICATIONS

This application is a non-provisional application claiming priority from the U.S. Provisional Patent Application No. 61/394,401, filed on Oct. 19, 2010, entitled “POLYETHYLENE COMPOSITIONS HAVING REDUCED PLATE OUT, AND FILMS MADE THEREFROM HAVING REDUCED BLOOMING,” the teachings of which are incorporated by reference herein, as if reproduced in full hereinbelow.

### FIELD OF INVENTION

The instant invention relates to polyethylene compositions having reduced plate out, and films made therefrom having reduced blooming.

### BACKGROUND OF THE INVENTION

Additives and/or one or more neutralizing agents are commonly used with polyolefin materials to impart various properties to polymeric materials to make them more suitable for their intended use. However, the addition of such additives may also have a negative impact on certain other properties. For example, the addition of certain antioxidants or neutralizing agents may cause plate out and/or blooming. The term “plate(ing) out,” as used herein, refers to the disposition of one or more residues, e.g. phosphite and oxidized phosphite residues, or residue mass derived from Octadecyl-3-(3,5-di-tert.butyl-4-hydroxyphenyl)-propionate, or an acid derivative of one or more neutralizing agents, such calcium stearate or zinc stearate, residue mass, such as stearic acid residue mass, from one or more additive materials from a molten polymer onto one or more surfaces of one or more equipments during the fabrication of films and/or articles made from such polyolefin materials. The term “bloom(ing),” as used herein refers to the migration of one or more residues, e.g. phosphite and oxidized phosphite residues, or residue mass derived from Pentaerythritol Tetrakis (3-(3,5-di-tert-butyl-4-hydroxyphenyl)propionate), from one or more additive materials to the exterior surface of a film and/or fabricated article.

As a result, the production lines may be required to shutdown to take appropriate measures to remove accumulated residual deposits from the surface of equipments. Such continuous maintenance creates additional undesired cost; thus, it is desired to minimize plate outs and bloomings.

However, despite the research efforts to reduce plating out and/or blooming, there is still a need for polyolefin compositions having reduced plating out, and films made therefrom having reduced blooming.

### SUMMARY OF THE INVENTION

The instant invention provides polyethylene compositions having reduced plate out, and films made therefrom having reduced blooming.

In one embodiment, the instant invention provides a polyethylene composition suitable for film applications comprising the melt blending product of: (a) an ethylene based polymer; (b) a first antioxidant system comprising one or more antioxidants selected from the group consisting of Octadecyl-3-(3,5-di-tert.butyl-4-hydroxyphenyl)-propionate; Pentaerythritol Tetrakis (3-(3,5-di-tert-butyl-4-hydroxyphenyl)propionate); and combinations thereof; (c) a second antioxidant system comprising a liquid phosphite corresponding to the formula [4-(2-methylbutan-2-yl)phenyl]x[2,4-bis(2-methylbutan-2-yl)phenyl]3-x phosphate, wherein x=0, 1, 2, 3, or combinations thereof; and (d) optionally one or more neutralizing agents.

In an alternative embodiment, the instant invention further provides a film comprising a polyethylene composition comprising the melt blending product of: (a) an ethylene based polymer; (b) a first antioxidant system comprising one or more antioxidants selected from the group consisting of Octadecyl-3-(3,5-di-tert.butyl-4-hydroxyphenyl)-propionate; Pentaerythritol Tetrakis (3-(3,5-di-tert-butyl-4-hydroxyphenyl)propionate); and combinations thereof; (c) a second antioxidant system comprising a liquid phosphite corresponding to the formula [4-(2-methylbutan-2-yl)phenyl]x[2,4-bis(2-methylbutan-2-yl)phenyl]3-x phosphate, wherein x=0, 1, 2, 3, or combinations thereof; and (d) optionally one or more neutralizing agents.

In an alternative embodiment, the instant invention provides a polyethylene composition, and a film made therefrom, in accordance with any of the preceding embodiments, except that when said polyethylene composition is cast extruded into a film, said polyethylene composition plates out a total phosphite and oxidized phosphite residue mass of less than or equal to 10,000 micrograms on the film extruder chill roll.

In an alternative embodiment, the instant invention provides a polyethylene composition, and a film made therefrom, in accordance with any of the preceding embodiments, except that when said polyethylene composition is cast extruded into a film, said polyethylene composition plates out a total phosphite and oxidized phosphite residue mass of less than or equal to 7,500 micrograms on the film extruder chill roll.

In an alternative embodiment, the instant invention provides a polyethylene composition, and a film made therefrom, in accordance with any of the preceding embodiments, except that when said polyethylene composition is cast extruded into a film, said polyethylene composition plates out a total phosphite and oxidized phosphite residue mass of less than or equal to 5,000 micrograms on the film extruder chill roll.

In an alternative embodiment, the instant invention provides a polyethylene composition, and a film made therefrom, in accordance with any of the preceding embodiments, except that when said polyethylene composition is cast extruded into a film, said polyethylene composition plates out a total residue mass derived from Octadecyl-3-(3,5-di-tert.butyl-4-hydroxyphenyl)-propionate of less than or equal to 8,000 micrograms on the film extruder chill roll.

In an alternative embodiment, the instant invention provides a polyethylene composition, and a film made therefrom, in accordance with any of the preceding embodiments, except that when said polyethylene composition is cast extruded into a film, said polyethylene composition plates out a total residue mass derived from Octadecyl-3-(3,5-di-tert.butyl-4-hydroxyphenyl)-propionate of less than or equal to 5,000 micrograms on the film extruder chill roll.

In an alternative embodiment, the instant invention provides a polyethylene composition, and a film made therefrom, in accordance with any of the preceding embodiments, except when the polyethylene composition is cast extruded into a film, the polyethylene composition plates out an acid derivative of the one or more neutralizing agents, e.g. calcium stearate or zinc stearate, residue mass, such as stearic acid residue mass, of less than or equal to 65,000 micrograms on the film extruder chill roll.

In an alternative embodiment, the instant invention provides a polyethylene composition, and a film made therefrom, in accordance with any of the preceding embodiments, except when the polyethylene composition is cast extruded into a film, the polyethylene composition plates out an acid derivative of the one or more neutralizing agents, e.g. calcium stearate or zinc stearate, residue mass, such as stearic acid residue mass, of less than or equal to 50,000 micrograms on the film extruder chill roll.

In an alternative embodiment, the instant invention provides a polyethylene composition, and a film made therefrom, in accordance with any of the preceding embodiments, except when the polyethylene composition is cast extruded into a film, the polyethylene composition plates out an acid derivative of the one or more neutralizing agents, e.g. calcium stearate or zinc stearate, residue mass, such as stearic acid residue mass, of less than or equal to 25,000 micrograms on the film extruder chill roll.

In an alternative embodiment, the instant invention provides a polyethylene composition, and a film made therefrom, in accordance with any of the preceding embodiments, except when the polyethylene composition is cast extruded into a film, the polyethylene composition plates out an acid derivative of the one or more neutralizing agents, e.g. calcium stearate or zinc stearate, residue mass, such as stearic acid residue mass, of less than or equal to 15,000 micrograms on the film extruder chill roll.

In an alternative embodiment, the instant invention provides a polyethylene composition, and a film made therefrom, in accordance with any of the preceding embodiments, except that when the polyethylene composition is cast extruded into a film, the polyethylene composition plates out an acid derivative of the one or more neutralizing agents, e.g. calcium stearate or zinc stearate, residue mass, such as stearic acid residue mass, of less than or equal to 10,000 micrograms on the film extruder chill roll.

In an alternative embodiment, the instant invention provides a polyethylene composition, and a film made therefrom, in accordance with any of the preceding embodiments, except that said polyethylene composition comprises from 250 to 2500 parts by weight of the first antioxidant system, based on one million parts of the ethylene based polymer, and from 500 to 2500 parts by weight of the second antioxidant system, based on one million parts of the ethylene based polymer, and optionally from 250 to 2500 parts by weight one or more neutralizing agents, based on one million parts of the ethylene based polymer.

In an alternative embodiment, the instant invention provides a film, in accordance with any of the preceding embodiments, except that said film blooms a total phosphite and oxidized phosphite residue mass of less than or equal to 1000 micrograms on a film black cloth.

In an alternative embodiment, the instant invention provides a film, in accordance with any of the preceding embodiments, except that said film blooms a total phosphite and oxidized phosphite residue mass of less than or equal to 750 micrograms on a film black cloth.

In an alternative embodiment, the instant invention provides a film, in accordance with any of the preceding embodiments, except that said film blooms a total residue mass derived from Pentaerythritol Tetrakis (3-(3,5-di-tert-butyl-4-hydroxyphenyl)propionate) of less than or equal to 10,000 micrograms on a film black cloth.

In an alternative embodiment, the instant invention provides a film, in accordance with any of the preceding embodiments, except that said film blooms a total residue mass derived from Pentaerythritol Tetrakis (3-(3,5-di-tert-butyl-4-hydroxyphenyl)propionate) of less than or equal to 5,000 micrograms on a film black cloth.

In an alternative embodiment, the instant invention provides a film, in accordance with any of the preceding embodiments, except that said film blooms a total residue mass derived from Pentaerythritol Tetrakis (3-(3,5-di-tert-butyl-4-hydroxyphenyl)propionate) of less than or equal to 1,000 micrograms on a film black cloth.

### DETAILED DESCRIPTION OF THE INVENTION

The instant invention provides polyethylene compositions having reduced plate out, and films made therefrom having reduced blooming. The polyethylene compositions according to the present invention are suitable for film applications and comprise the melt blending product of: (a) an ethylene based polymer; (b) a first antioxidant system comprising one or more antioxidants selected from the group consisting of Octadecyl-3-(3,5-di-tert.butyl-4-hydroxyphenyl)-propionate; Pentaerythritol Tetrakis (3-(3,5-di-tert-butyl-4-hydroxyphenyl)propionate); and combinations thereof; (c) a second antioxidant system comprising a liquid phosphite corresponding to the formula [4-(2-methylbutan-2-yl)phenyl]x[2,4-bis(2-methylbutan-2-yl)phenyl]3-x phosphate, wherein x=0, 1, 2, 3, or combinations thereof; and (d) optionally one or more neutralizing agents.

The polyethylene compositions according to the present invention plate out a total phosphite and oxidized phosphite residue mass of less than or equal to 10,000 micrograms on the film extruder chill roll when the inventive polyethylene compositions are cast extruded into films; for example, less than or equal to 8,000 micrograms; or in the alternative, less than or equal to 7,500 micrograms; or in the alternative, less than or equal to 5,000 micrograms. The inventive polyethylene composition plates out a total residue mass derived from Octadecyl-3-(3,5-di-tert.butyl-4-hydroxyphenyl)-propionate of less than or equal to 8,000 micrograms on the film extruder chill roll when the polyethylene composition is cast extruded into a film; for example, less than 5000 micrograms. The term “plate(ing) out,” as used herein, refers to the disposition of one or more residues, e.g. phosphite and oxidized phosphite residues or residue mass derived from Octadecyl-3-(3,5-di-tert.butyl-4-hydroxyphenyl)-propionate, or residue mass derived from Octadecyl-3-(3,5-di-tert.butyl-4-hydroxyphenyl)-propionate, or an acid derivative of one or more neutralizing agents, such calcium stearate or zinc stearate, residue mass, such as stearic acid residue mass, from one or more additive materials from a molten polymer onto one or more surfaces of one or more equipments during the fabrication of films and/or articles made from such polyolefin materials.

The polyethylene compositions of the present invention are suitable for film applications. Films comprising the inventive polyethylene compositions of the present invention possess improved and unexpected properties; for example, films comprising the polyethylene compositions of the present invention bloom a total phosphite and oxidized phosphite residue mass of less than or equal to 1000 micrograms on a black cotton cloth; or in the alternative, films comprising the polyethylene compositions of the present invention bloom a total phosphite and oxidized phosphite residue mass of less than or equal to 750 micrograms on a black cotton cloth. In addition, films comprising the inventive polyethylene compositions of the present invention bloom a total residue mass derived from Pentaerythritol Tetrakis (3-(3,5-di-tert-butyl-4-hydroxyphenyl)propionate) of less than or equal to 10,000 micrograms on a black cotton cloth; or in the alternative, films comprising the polyethylene compositions of the present invention bloom a total residue mass derived from Pentaerythritol Tetrakis (3-(3,5-di-tert-butyl-4-hydroxyphenyl)propionate) of less than or equal to 5,000 micrograms on a black cotton cloth; or in the alternative, films comprising the polyethylene compositions of the present invention bloom a total residue mass derived from Pentaerythritol Tetrakis (3-(3,5-di-tert-butyl-4-hydroxyphenyl)propionate) of less than or equal to 1,000 micrograms on a black cotton cloth. The term “bloom(ing),” as used herein refers to the migration of one or more residues, e.g. phosphite and oxidized phosphite residues or residue mass derived from Pentaerythritol Tetrakis (3-(3,5-di-tert-butyl-4-hydroxyphenyl)propionate), from one or more additive materials to the exterior surface of a film and/or fabricated article.

### Ethylene Based Polymer

The polyethylene composition comprises from greater than 90 percent by weight of at least one ethylene based polymer, based on the total weight of the polyethylene composition; for example, from greater than 95 weight percent; or in the alternative, from greater than 98 weight percent, based on the total weight of the polyethylene composition.

The ethylene based polymer has a density in the range of from 0.890 to 0.965 g/cm³; for example, a density in the range of from 0.900 to 0.950 g/cm³; or in the alternative, a density in the range of from 0.915 to 0.920 g/cm³. The density can be from a lower limit of 0.890 g/cm³, 0.900 g/cm³, or 0.915 g/cm³ to an upper limit of 0.965 g/cm³, 0.950 g/cm³, 0.930 g/cm³, or 0.920 g/cm³.

The ethylene based polymer has a melt index (I₂) in the range of from 0.001 to 100 g/10 minutes; for example, a melt index (I₂) in the range of from 0.01 to 50 g/10 minutes; or in the alternative, a melt index (I₂) in the range of from 0.01 to 25 g/10 minutes; or in the alternative, a melt index (I₂) in the range of from 0.01 to 10 g/10 minutes; or in the alternative, or a melt index (I₂) in the range of from 0.01 to 6 g/10 minutes; or in the alternative, a melt index (I₂) in the range of from 0.7 to 4 g/10 minutes; or in the alternative, a melt index (I₂) in the range of from 0.85 to 4 g/10 minutes; or in the alternative, a melt index (I₂) in the range of from 1 to 4 g/10 minutes; or in the alternative, a melt index (I₂) in the range of from 0.7 to 2.3 g/10 minutes; or in the alternative, a melt index (I₂) in the range of from 0.85 to 2.3 g/10 minutes; or in the alternative, a melt index (I₂) in the range of from 1 to 2.3 g/10 minutes.

The ethylene based polymer has a melt flow ratio (I₁₀/I₂) in the range of from less than 20, for example, in the range of from less than 18; or in the alternative, in the range of from less than 16; or in the alternative, in the range of from 5.5 to 10; or in the alternative, in the range of from 7.5 to 9; or in the alternative, in the range of from 8 to 10.

The ethylene based polymer has a molecular weight (M_{w}) in the range of from 50,000 to 300,000 g/mole, for example, in the range of from 50,000 to 250,000 g/mole.

The ethylene based polymer may comprise less than 20 percent by weight of units derived from one or more α-olefin comonomers. All individual values and subranges from less than 18 weight percent are included herein and disclosed herein; for example, the ethylene based polymer may comprise less than 15 percent by weight of units derived from one or more α-olefin comonomers; or in the alternative, the ethylene based polymer may comprise less than 10 percent by weight of units derived from one or more α-olefin comonomers; or in the alternative, the ethylene based polymer may comprise from 1 to 20 percent by weight of units derived from one or more α-olefin comonomers; or in the alternative, the ethylene based polymer may comprise from 1 to 10 percent by weight of units derived from one or more α-olefin comonomers.

The ethylene based polymer may comprise less than 10 percent by moles of units derived from one or more α-olefin comonomers. All individual values and subranges from less than 10 mole percent are included herein and disclosed herein; for example, the ethylene based polymer may comprise less than 7 percent by moles of units derived from one or more α-olefin comonomers; or in the alternative, the ethylene based polymer may comprise less than 4 percent by moles of units derived from one or more α-olefin comonomers; or in the alternative, the ethylene based polymer may comprise less than 3 percent by moles of units derived from one or more α-olefin comonomers; or in the alternative, the ethylene based polymer may comprise from 0.5 to 10 percent by moles of units derived from one or more α-olefin comonomers; or in the alternative, the ethylene based polymer may comprise from 0.5 to 3 percent by moles of units derived from one or more α-olefin comonomers.

The α-olefin comonomers typically have no more than 20 carbon atoms. For example, the α-olefin comonomers may preferably have 3 to 10 carbon atoms, and more preferably 3 to 8 carbon atoms. Exemplary α-olefin comonomers include, but are not limited to, propylene, 1-butene, 1-pentene, 1-hexene, 1-heptene, 1-octene, 1-nonene, 1-decene, and 4-methyl-1-pentene. The one or more α-olefin comonomers may, for example, be selected from the group consisting of propylene, 1-butene, 1-hexene, and 1-octene; or in the alternative, from the group consisting of 1-hexene and 1-octene.

The ethylene based polymer may comprise at least 80 percent by weight of units derived from ethylene. All individual values and subranges from at least 80 weight percent are included herein and disclosed herein; for example, the ethylene based polymer may comprise at least 82 percent by weight of units derived from ethylene; or in the alternative, the ethylene based polymer may comprise at least 85 percent by weight of units derived from ethylene; or in the alternative, the ethylene based polymer may comprise at least 90 percent by weight of units derived from ethylene; or in the alternative, the ethylene based polymer may comprise from 80 to 99 percent by weight of units derived from ethylene; or in the alternative, the ethylene based polymer may comprise from 90 to 99 percent by weight of units derived from ethylene.

The ethylene based polymer may comprise at least 90 percent by moles of units derived from ethylene. All individual values and subranges from at least 90 mole percent are included herein and disclosed herein; for example, the ethylene based polymer may comprise at least 93 percent by moles of units derived from ethylene; or in the alternative, the ethylene based polymer may comprise at least 96 percent by moles of units derived from ethylene; or in the alternative, the ethylene based polymer may comprise at least 97 percent by moles of units derived from ethylene; or in the alternative, the ethylene based polymer may comprise from 90 to 99.5 percent by moles of units derived from ethylene; or in the alternative, ethylene based polymer may comprise from 97 to 99.5 percent by moles of units derived from ethylene.

Any conventional polymerization processes may be employed to produce the ethylene based polymer. Such conventional polymerization processes include, but are not limited to, solution polymerization process, gas phase polymerization process, slurry phase polymerization process, and combinations thereof using one or more conventional reactors e.g. loop reactors, isothermal reactors, fluidized bed gas phase reactors, stirred tank reactors, batch reactors, in parallel, series, and/or any combinations thereof.

### First Antioxidant System

The polyethylene composition comprises from 250 to 2500 parts by weight of the first antioxidant system, based on one million parts of the ethylene based polymer; for example, from 350 to 1500 parts by weight of the first antioxidant system, based on one million parts of the ethylene based polymer.

The first antioxidant system comprises one or more antioxidants. Such one or more antioxidants include, but are not limited to, hindered phenols. Such one or more antioxidants may, for example, be selected from the group consisting of Octadecyl-3-(3,5-di-tert.butyl-4-hydroxyphenyl)-propionate (CAS 002082-79-3) commercially available as IRGANOX™ 1076; Pentaerythritol Tetrakis (3-(3,5-di-tert-butyl-4-hydroxyphenyl)propionate) (CAS 6683-19-8) commercially available as IRGANOX™ 1010; and combinations thereof.

### Second Antioxidant System

The polyethylene composition comprises from 500 to 2500 parts by weight of the second antioxidant system, based on one million parts of the ethylene based polymer; for example, from 750 to 1500 parts by weight of the second antioxidant system, based on one million parts of the ethylene based polymer.

The second antioxidant system comprises a liquid phosphite corresponding to the formula [4-(2-methylbutan-2-yl)phenyl]x[2,4-bis(2-methylbutan-2-yl)phenyl]3-x phosphate, wherein x=0, 1, 2, 3, or combinations thereof. Such liquid phosphite antioxidants are, for example, commercially available under the tradename WESTON™ 705, from Chemtura Corporation.

### Neutralizing Agents

The polyethylene composition may optionally comprise from 250 to 2500 parts by weight one or more neutralizing agents, based on one million parts of the ethylene based polymer; for example, from 350 to 1500 parts by weight one or more neutralizing agents, based on one million parts of the ethylene based polymer.

The one or more neutralizing agents include, but are not limited to, calcium stearate, zinc stearate, synthetic hydrotalcite, such as DHT4A, and combinations thereof.

### Additional Components

The polyethylene composition may further comprise additional components such as other polymers and/or additives. Such additives include, but are not limited to, antistatic agents, color enhancers, dyes, lubricants, fillers, pigments, additional primary and/or secondary antioxidants, processing aids, UV stabilizers, and combinations thereof. The polyethylene composition may contain any amounts of additional additives. The polyethylene composition may, for example, comprise from about 0 to about 10 percent by the combined weight of such additives, based on the weight of the polyethylene composition including such additives. All individual values and subranges from about 0 to about 10 weight percent are included herein and disclosed herein; for example, the polyethylene composition may comprise from 0 to 7 percent by the combined weight of additional additives; in the alternative, the polyethylene composition may comprise from 0 to 5 percent by the combined weight of additional additives; or in the alternative, the polyethylene composition may comprise from 0 to 3 percent by the combined weight of additional additives; or in the alternative, the polyethylene composition may comprise from 0 to 2 percent by the combined weight of additional additives; or in the alternative, the polyethylene composition may comprise from 0 to 1 percent by the combined weight of additional additives; or in the alternative, the inventive polyethylene composition may comprise from 0 to 0.5 percent by the combined weight of additional additives.

### Process for Producing the Polyethylene Composition

The first antioxidant system, second antioxidant system, one or more neutralizing agents, and/or one or more additional components may be added to the ethylene based polymer in any way known to a person of ordinary skill in the art, including, but not limited to, via masterbatch and blend mixing. An ethylene-based polymer can advantageously be used as a polymer carrier for forming a masterbatch for the first antioxidant system, second antioxidant system, one or more neutralizing agents, and/or one or more additional components.

### Films and Process for Making the Films

The polyethylene compositions of the present invention are suitable for film applications. Films comprising the inventive polyethylene compositions of the present invention possess improved and unexpected properties; for example, films comprising the polyethylene compositions of the present invention bloom a total phosphite and oxidized phosphite residue mass of less than or equal to 1000 micrograms on a black cotton cloth; or in the alternative, films comprising the polyethylene compositions of the present invention bloom a total phosphite and oxidized phosphite residue mass of less than or equal to 750 micrograms on a black cotton cloth. In addition, films comprising the inventive polyethylene compositions of the present invention bloom a total residue mass derived from Pentaerythritol Tetrakis (3-(3,5-di-tert-butyl-4-hydroxyphenyl)propionate) of less than or equal to 10,000 micrograms on a black cotton cloth; or in the alternative, films comprising the polyethylene compositions of the present invention bloom a total residue mass derived from Pentaerythritol Tetrakis (3-(3,5-di-tert-butyl-4-hydroxyphenyl)propionate) of less than or equal to 5,000 micrograms on a black cotton cloth; or in the alternative, films comprising the polyethylene compositions of the present invention bloom a total residue mass derived from Pentaerythritol Tetrakis (3-(3,5-di-tert-butyl-4-hydroxyphenyl)propionate) of less than or equal to 1,000 micrograms on a black cotton cloth. The term “bloom(ing),” as used herein refers to the migration of one or more residues, e.g. phosphite and oxidized phosphite residues or residue mass derived from Pentaerythritol Tetrakis (3-(3,5-di-tert-butyl-4-hydroxyphenyl)propionate), from one or more additive materials to the exterior surface of a film and/or fabricated article.

In application, the polyethylene composition of the present invention or blend thereof with one or more other polymers may be used to manufacture films. Such films may include, but are not limited to, clarity shrink films, collation shrink films, cast stretch films, silage films, stretch hooder films, sealants, stand up pouch films, liner films, machine direction oriented films, and diaper backsheets. Different methods may be employed to manufacture such films. Suitable conversion techniques include, but are not limited to, blown film process, cast film process, tenter frame process, double bubble process, such as partially crosslinked or non-crosslinked, vertical or horizontal form fill and seal process. Such techniques are generally well known. In one embodiment, the conversion technique includes, but is not limited to, the cast film process.

The films according to the present invention may include at least one film layer, such as a monolayer film comprising the inventive polyethylene composition or blend thereof with one or more other polymers, or at least one layer comprising the inventive polyethylene composition or blend thereof with one or more other polymers in a multilayer film prepared by cast, blown, calendered, or extrusion coating processes. In a multilayer film structure, the inventive film, i.e. at least one layer comprising the inventive polyethylene composition or blend thereof with one or more other polymers, may be an interior layer, a contact layer, or an exterior layer. The polyethylene composition of the present invention or blend thereof with one or more other polymers may be used in a variety of films, including but not limited to clarity shrink films, collation shrink films, cast stretch films, silage films, stretch hooder films, sealants, stand up pouch films, liner films, machine direction oriented films, and diaper backsheets.

The films according to the present invention may have any thickness; for example, the films according to the present invention may a thickness in the range of from 0.05 to 10 mils; or in the alternative, a thickness in the range of from 0.3 to 10 mils; or in the alternative, a thickness in the range of from 0.3 to 2 mils; or in the alternative, a thickness in the range of from 0.3 to 1.2 mils.

### EXAMPLES

The following examples illustrate the present invention but are not intended to limit the scope of the invention. The inventive examples demonstrate that the polyethylene compositions of the present invention plate out a total phosphite and oxidized phosphite residue mass of less than or equal to 10,000 micrograms on the film extruder chill roll when the polyethylene composition is cast extruded into a film while films comprising the polyethylene compositions of the present invention bloom a total phosphite and oxidized phosphite residue mass of less than or equal to 1000 micrograms on a black cotton cloth.

### Inventive Composition 1

Inventive Composition 1 comprises (a) approximately 99.8 percent by weight of an ethylene/1-octene copolymer having a density of approximately 0.917 g/cm³, measured in accordance with ASTM D-792, a melt index (I₂) of approximately 2.3 g/10 minutes, measured in accordance with ASTM D-1238, at 190° C. and 2.16 kg, which was provided by The Dow Chemical Company; (b) 0.045 percent by weight of the first antioxidant system (0.025 weight percent of IRGANOX 1076, and 0.020 weight percent of IRGANOX 1010); (c) 0.10 percent by weight of the second antioxidant system (Liquid WESTON 705); and (d) 0.05 percent by weight of a neutralizing agent (DHT4A). Inventive Composition 1 was formed into Inventive Film 1 and evaluated for plate out properties, and these plate out properties are reported in Table 2.

### Comparative Composition A

Comparative Composition A comprises (a) approximately 99.8 percent by weight of an ethylene/1-octene copolymer having a density of approximately 0.917 g/cm³, measured in accordance with ASTM D-792, a melt index (I₂) of approximately 2.3 g/10 minutes, measured in accordance with ASTM D-1238, at 190° C. and 2.16 kg, which is commercially available under the tradename DOWLEX™ 2247G from The Dow Chemical Company; (b) 0.045 percent by weight of the first antioxidant system (0.025 weight percent of IRGANOX 1076, and 0.020 weight percent of IRGANOX 1010); (c) 0.10 percent by weight of IRGAFOS 168; and (d) 0.05 percent by weight of a neutralizing agent (DHT4A). Comparative Composition A was formed into Comparative Film A and evaluated for plate out properties, according to the following procedure, and these plate out properties are reported in Table 2.

### Inventive Composition 2

Inventive Composition 2 comprises (a) approximately 99.8 percent by weight of an ethylene/1-octene copolymer having a density of approximately 0.917 g/cm³, measured in accordance with ASTM D-792, a melt index (I₂) of approximately 2.3 g/10 minutes, measured in accordance with ASTM D-1238, at 190° C. and 2.16 kg, which was provided by The Dow Chemical Company; (b) 0.045 percent by weight of the first antioxidant system (0.025 weight percent of IRGANOX 1076, and 0.020 weight percent of IRGANOX 1010); (c) 0.10 percent by weight of the second antioxidant system (Liquid WESTON 705); and (d) 0.08 percent by weight of two neutralizing agents (0.05 weight percent of DHT4A and 0.03 of Calcium Stearate). Inventive Composition 2 was formed into Inventive Film 2 and evaluated for plate out properties, according to the following procedure, and these plate out properties are reported in Table 3.

### Comparative Composition B

Comparative Composition B comprises (a) approximately 99.8 percent by weight of an ethylene/1-octene copolymer having a density of approximately 0.917 g/cm³, measured in accordance with ASTM D-792, a melt index (I₂) of approximately 4.0 g/10 minutes, measured in accordance with ASTM D-1238, at 190° C. and 2.16 kg, which is commercially available under the tradename ELITE™ 5230G from The Dow Chemical Company; (b) 0.045 percent by weight of the first antioxidant system (0.025 weight percent of IRGANOX 1076, and 0.020 weight percent of IRGANOX 1010); (c) 0.10 percent by weight of IRGAFOS 168; and (d) 0.08 percent by weight of two neutralizing agents (0.05 weight percent of DHT4A and 0.03 of Calcium Stearate). Comparative Composition B was formed into Comparative Film B and evaluated for plate out properties, according to the following procedure, and these plate out properties are reported in Table 3.

### Inventive Films 1-2 and Comparative Films A-B

Inventive Compositions 1-2 and Comparative Compositions A-B were converted into Inventive Film 1, Inventive Film 2, Comparative Film A, and Comparative Film B, respectively, according to the following process. Inventive Films 1-2 and Comparative Films A-B were evaluated for their blooming properties, and these properties are reported in Table 2 and 3. Films are fabricated on a 5 layer Egan Davis Standard coextrusion cast film line, consisting of three 2½″ and two 2″ 30:1 L/D Egan Davis Standard MAC extruders, which are air cooled. All extruders have moderate work DSB (Davis Standard Barrier) type screws. A CMR 2000 microprocessor monitors and controls operations. The extrusion process is monitored by pressure transducers located before and after the breaker plate as well as four heater zones on each barrel, one each at the adapter and the block and two zones on the die. The microprocessor also tracks the extruder RPM, % FLA, horsepower, rate, line speed, % draw, primary and secondary chill roll temperatures, gauge deviation, layer ratio, rate/RPM, and melt temperature for each extruder.

Equipment specifications include a Cloeren 5 layer dual plane feed block and a Cloeren 36″ Epich II autogage 5.1 die. The primary chill roll has a matte finish and is 40″ O.D.×40″ long with a 30-40 RMS surface finish for improved release characteristics. The secondary chill roll is 20″ O.D.×40″ long with a 2-4 RMS surface for improved web tracking. Both the primary and secondary chill roll has chilled (about 10° C.) water circulating through it to provide quenching. There is an NDC Beta gauge sensor for gauge thickness and automatic gauge control if needed. Rate is measured by five Barron weigh hoppers with load cells on each hopper for gravimetric control. Samples are finished on the two position single turret Horizon winder on 3″ I.D. cores with center wind automatic roll changeover and slitter station. The maximum throughput rate for the line is 600 pounds per hour and maximum line speed is 900 feet per minute.

The following conditions are used for sample preparation:

TABLE 1

| Condition | Measurement | |
|---|---|---|
| Melt Temperature | 550° F. | |
| Line Speed | 360 | ft/min |
| Throughput Rate | 550-600 | lb/hr |
| Chill Roll Temperature | 90° F. | |
| Cast Roll Temperature | 70° F. | |
| Air Knife | 6″ H₂O | |
| Vacuum Box | Off | |
| Die Gap | 20-25 | mil |

These conditions typically produce maximum amount of sheer stress when processing in order to produce elevated amounts of chill roll plate out.

### Sampling for Plate Out Determination

Before film extrusion begins, the chill roll and the plate out roll are cleaned extensively using glass cleaner. The plate out roll is a rubber roll that when contacted with the chill roll can remove plate out deposits from the chill roll. The plate out roll was engaged only to clean the chill roll before extrusion begins. After the chill roll is initially cleaned, the plate out roll is disengaged. The film extruder is started up and when process conditions are lined out at steady state, chill roll deposits are allowed to build up for three hours. To collect a sample of plate out from the chill roll, a rubber sanding block covered with a piece of black cotton cloth is used. The chill roll deposit or “plate out,” is collected by taking the sanding block and cloth and pressing against the back side of the chill roll. The sanding block and cloth is then moved across the width of the chill roll for a sampling time of one minute.

### Residue Analysis for Plate Out Determination

The black cloth is placed in a bottle and a suitable amount of isopropanol is added to wet and extract residues from the entire cloth. The volume of isopropanol is recorded then the sample is sonicated for 15 minutes to dissolve residues. This extract is analyzed directly by liquid chromatography to separate and quantify the amount of phosphite, oxidized phosphite and any other primary antioxidant present.

If stearic acid is present, 1.0. mL of the isopropanol solution is evaporated to dryness, then 0.9 mL of acetonitrile is added followed by 0.1 mL of a mixture of 99% N-O-bis(trimethylsilyl)trifluoroacetamide+1% trimethyl chloro silane. This mixture is allowed to stand for one hour then it is analyzed by gas chromatography (“GC”) to quantify the stearic acid.

### Sampling for Blooming Determination

A monolayer film roll sample of 0.8 mil is collected for the blooming test. A film roll of at least 1500 feet in length is collected from the cast line and aged in an oven for 4 weeks at 40° C. After the aging period, the film roll is allowed to cool down for 24 hours before it is tested for blooming. The film roll is subjected to rewinding on rewinding equipment (Make-John and Dusenbery). In this test a black cotton cloth is tied onto one of the guide rolls of the winder. This roll is held stationary and the film is allowed to pass over this roll during the rewinding operation. A 1,500 foot length of film is rewound at a speed of approximately 50 ft/min. The black cloth is removed from the guide roll and submitted for analysis.

### Residue Analysis for Blooming Determination

The black cloth is placed in a bottle and a suitable amount of isopropanol is added to wet and extract residues from the entire cloth. The volume of isopropanol is recorded then the sample is sonicated for 15 minutes to dissolve residues. This extract can be analyzed directly by liquid chromatography to separate and quantify the amount of phosphite, oxidized phosphite and any other primary antioxidant present. Alternatively, if residue amounts are low, the isopropanol extract is concentrated by evaporating some of the isopropanol before liquid chromatography is performed.

TABLE 2

| | | Total Phosphite | Total Residue | Total Residue |
|---|---|---|---|---|
| | | Residue Mass | Mass derived | Mass derived |
| | | (from Weston 705 | from IRGANOX | from IRGANOX |
| | | or Irgafos 168) | 1010 | 1076 |
| Sample Number | Residue Type | (Micrograms) | (Micrograms) | (Micrograms) |
| Inventive | Plate Out | 1700 | 150 | 1600 |
| Composition 1 | | | | |
| Comparative | Plate Out | 67000 | 140 | 8400 |
| Composition A | | | | |
| Inventive Film 1 | Blooming | 130 | 60 | 0 |
| Comparative Film A | Blooming | 1800 | 14000 | 0 |

TABLE 3

| | | Total | Total Residue | Total Residue | Total Residue |
|---|---|---|---|---|---|
| | | Phosphite | Mass derived | Mass derived | Mass derived |
| | | Residue Mass | from | from | from Calcium |
| | | (from Weston 705 | IRGANOX | IRGANOX | Stearate |
| Sample | | or Irgafos 168) | 1010 | 1076 | (Stearic Acid) |
| Number | Residue Type | (Micrograms) | (Micrograms) | (Micrograms) | (Micrograms) |
| Inventive | Plate Out | 1100 | 110 | 1100 | 7000 |
| Composition 2 | | | | | |
| Comparative | Plate Out | 51000 | 0 | 700 | 75000 |
| Composition B | | | | | |
| Inventive Film 2 | Blooming | 150 | 60 | 0 | 4500 |
| Comparative | Blooming | 1600 | 11000 | 0 | 400 |
| Film B | | | | | |

### Test Methods

Test methods include the following:

### Density

Density (g/cm³) is measured according to ASTM-D 792-03, Method B, in isopropanol. Specimens are measured within 1 hour of molding after conditioning in the isopropanol bath at 23° C. for 8 min to achieve thermal equilibrium prior to measurement. The specimens are compression molded according to ASTM D-4703-00 Annex A with a 5 min initial heating period at about 190° C. and a 15° C./min cooling rate per Procedure C. The specimen is cooled to 45° C. in the press with continued cooling until “cool to the touch.”

### Melt Index

Melt index (I₂) is measured in accordance with ASTM D-1238, Condition 190° C./2.16 kg, and is reported in grams eluted per 10 minutes. I₁₀ is measured in accordance with ASTM D-1238, Condition 190 ° C./10 kg, and is reported in grams eluted per 10 minutes.

The present invention may be embodied in other forms without departing from the spirit and the essential attributes thereof, and, accordingly, reference should be made to the appended claims, rather than to the foregoing specification, as indicating the scope of the invention.

1. A polyethylene composition suitable for film applications comprising the melt blending product of:
an ethylene based polymer;
a first antioxidant system comprising one or more antioxidants selected from the group consisting of Octadecyl-3-(3,5-di-tert.butyl-4-hydroxyphenyl)-propionate; Pentaerythritol Tetrakis (3-(3,5-di-tert-butyl-4-hydroxyphenyl)propionate); and combinations thereof;
a second antioxidant system comprising a liquid phosphite corresponding to the formula [4-(2-methylbutan-2-yl)phenyl]x[2,4-bis(2-methylbutan-2-yl)phenyl]3-x phosphate, wherein x=0, 1, 2, 3, or combinations thereof; and
optionally one or more neutralizing agents.

2. The polyethylene composition suitable for film applications according to claim 1, wherein when said polyethylene composition is cast extruded into a film, said polyethylene composition plates out a total phosphite and oxidized phosphite residue mass of less than or equal to 10,000 micrograms on the film extruder chill roll.

3. The polyethylene composition suitable for film applications according to claim 1, wherein when said polyethylene composition is cast extruded into a film, said polyethylene composition plates out a total phosphite and oxidized phosphite residue mass of less than or equal to 7,500 micrograms on the film extruder chill roll.

4. The polyethylene composition suitable for film applications according to claim 1, wherein when said polyethylene composition is cast extruded into a film, said polyethylene composition plates out a total phosphite and oxidized phosphite residue mass of less than or equal to 5,000 micrograms on the film extruder chill roll.

5. The polyethylene composition suitable for film applications according to claim 1, wherein when said polyethylene composition is cast extruded into a film, said polyethylene composition plates out a total residue mass derived from Octadecyl-3-(3,5-di-tert.butyl-4-hydroxyphenyl)-propionate of less than or equal to 8,000 micrograms on the film extruder chill roll.

6. The polyethylene composition suitable for film applications according to claim 1, wherein when said polyethylene composition is cast extruded into a film, said polyethylene composition plates out a total residue mass derived from Octadecyl-3-(3,5-di-tert.butyl-4-hydroxyphenyl)-propionate of less than or equal to 5,000 micrograms on the film extruder chill roll.

7. The polyethylene composition suitable for film applications according to claim 1, wherein when said polyethylene composition is cast extruded into a film, said polyethylene composition plates out an acid derivative of the one or more neutralizing agents residue mass of less than or equal to 65,000 micrograms on the film extruder chill roll.

8. The polyethylene composition suitable for film applications according to claim 1, wherein when said polyethylene composition is cast extruded into a film, said polyethylene composition plates out an acid derivative of the one or more neutralizing agents residue mass of less than or equal to 50,000 micrograms on the film extruder chill roll.

9. The polyethylene composition suitable for film applications according to claim 1, wherein when said polyethylene composition is cast extruded into a film, said polyethylene composition plates out an acid derivative of the one or more neutralizing agents residue mass of less than or equal to 25,000 micrograms on the film extruder chill roll.

10. The polyethylene composition suitable for film applications according to claim 1, wherein when said polyethylene composition is cast extruded into a film, said polyethylene composition plates out an acid derivative of the one or more neutralizing agents residue mass of less than or equal to 15,000 micrograms on the film extruder chill roll.

11. The polyethylene composition suitable for film applications according to claim 1, wherein when said polyethylene composition is cast extruded into a film, said polyethylene composition plates out an acid derivative of the one or more neutralizing agents residue mass of less than or equal to 10,000 micrograms on the film extruder chill roll.

12. The polyethylene composition suitable for film applications according to claim 1, wherein said polyethylene composition comprises from 250 to 2500 parts by weight of the first antioxidant system, based on one million parts of the ethylene based polymer, and from 500 to 2500 parts by weight of the second antioxidant system, based on one million parts of the ethylene based polymer, and optionally from 250 to 2500 parts by weight one or more neutralizing agents, based on one million parts of the ethylene based polymer.

13. A film comprising a polyethylene composition according to claim 1, wherein said film blooms a total phosphite and oxidized phosphite residue mass of less than or equal to 1000 micrograms on a black cotton cloth.

14. The film according to claim 13, wherein said film blooms a total phosphite and oxidized phosphite residue mass of less than or equal to 750 micrograms on a black cotton cloth.

15. A film comprising a polyethylene composition according to claim 1, wherein said film blooms a total residue mass derived from Pentaerythritol Tetrakis (3-(3,5-di-tert-butyl-4-hydroxyphenyl)propionate) of less than or equal to 10,000 micrograms on a black cotton cloth.

16. A film comprising a polyethylene composition according to claim 1, wherein said film blooms a total residue mass derived from Pentaerythritol Tetrakis (3-(3,5-di-tert-butyl-4-hydroxyphenyl)propionate) of less than or equal to 5,000 micrograms on a black cotton cloth.

17. A film comprising a polyethylene composition according to claim 1, wherein said film blooms a total residue mass derived from Pentaerythritol Tetrakis (3-(3,5-di-tert-butyl-4-hydroxyphenyl)propionate) of less than or equal to 1,000 micrograms on a black cotton cloth.
